(19) United States
(12) Patent Application Publication
(10) Pub. No.: US 2006/0119015 A1
(43) Pub. Date: Jun. 8, 2006

(54) Method for producing hollow fibres

(75) Inventors: Ralf Wehrspohn, Halle (DE); Nielsch Bornelius, Halle (DE); Steinhart Martin, Marburg (DE); Greiner Andreas, Amoneburg (DE); Wendorff Joachim, Marburg (DE)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: MAX-Planck-Gesellschaft zur Forderung der Wissensc, Munchen (DE)

(21) Appl. No.: 10/507,311

(22) PCT Filed: Mar. 11, 2003
(86) PCT No.: PCT/EP03/76702

§ 371 Date: Oct. 7, 2005

(30) Foreign Application Priority Data
Mar. 11, 2002 (DE) 102 10 626.6

(51) Int. Cl. B28B 1/00

(52) U.S. Cl. 264/627; 264/640; 264/637

(57) ABSTRACT

The invention relates to a method for producing hollow fibres, in particular for producing meso- and nanotubes, whose tubes or hollow fibres have an internal diameter in the nano- to micrometre range and are preferably aligned in one direction. The invention also relates to the use of said hollow fibres, to hollow fibres or tubes produced by said method and to composite materials containing the hollow fibres or tubes.

### SPECIFICATION

The invention relates to a process for the production of hollow fibers, in particular for the production of meso- and nanotubes, wherein the tubes or hollow fibers with an internal diameter in the nano- to micrometer range are preferably aligned in one direction, and the use thereof. A further object of this invention are the hollow fibers or tubes produced by this process and porous composite materials containing these.

Tubes or hollow fibers with an internal diameter of <0.1 mm are also described as meso- or nanotubes. In the last decade, nanotubes of polymeric materials in particular have become important, since they can be used for various purposes, for example for the storage or the transportation of gases or liquids, in fuel cells, in near-field optics, in nanoelectronics and in combinatorial chemistry, and in the fields of catalysis and drug administration. Regular arrays of nanotubes are of particular interest, since these are for example also suitable for use in filtration, hydrogen storage, fabric production or in photonic crystals.

The use of nanotubes for separative purposes is also known, for example in medical dialysis, for gas separation or osmosis in aqueous systems, for example for water treatment (see Kirk Othmer, Encyclopedia of Chemical Technology, 4^{th} Ed., Vol. 13, 312-313). The tube material consists mostly of polymers, which can moreover possess pores, i.e. semipermeable membrane properties. The hollow fibers used for separative purposes mostly have an area of 100 cm²/cm³ volume with an internal diameter from 75 μm to 1 mm.

The use of hollow fibers in microelectronics is also known. Here, superconducting fibers ca. 60 μm in diameter are produced by filling hollow fibers made of polymers with a mixture which after thermal degradation of the polymer possesses superconducting properties (J. C. W. Chien, H. Ringsdorf et al., Adv. Mater., 2 (1990), 305).

Tubes with an internal diameter of 2 μm or greater can be produced by extrusion spinning processes. A number of extrusion spinning processes are described in Kirk-Othmer, Encyclopedia of Chemical Technology, 4^{th} Ed., Vol. 13, 317-322). However, the production of hollow fibers with smaller internal diameters is not possible with this process.

U.S. Pat. No. 4,689,186 describes an electrospinning process for the creation of tubular products with a head spindle, in which some of the fibers are laid down in the stretched state in the direction of the circumference by means of an auxiliary electrode, so that after removal of the spindle a lower diameter of the tubes is attained by drawing together the tensioned fiber shell. This process is however costly and limited with regard to the materials suitable for it.

For the production of nanotubes with small internal diameters, two fundamentally different methods have hitherto been used: self-organization and the use of templates. The self-organization method has been described by several authors, for example by G. M. Whitesides et al. in Science 254 (1991), 1312. The disadvantage of this method consists in the fact that it is only usable on a limited number of starting materials, such as for example carbon or boron nitride, lipid surfactants (surface-active substances) and polypeptides and thus the choice of materials for the nanotubes is limited.

For the second method, the use of templates, there are two different possibilities. In one of them, nanotubes can be polymerized in the pores of nanoporous materials, during which the polymerization begins at the. walls of the pores and, depending on the duration of the polymerization, tubes of defined wall thickness or compact, filled nanofibers are obtained, as for example described by C. R. Martin in Science 266 (1994) 1961 ff. In the process, the shape of the template is reproduced. Depending on the choice of the template material, it is possible selectively to remove the template material, in order to obtain the nanotubes themselves.

With the other possibility which relies on the use of templates, thin fibers are produced as templates by an electrospinning process, which are for example coated with polymers by chemical gas phase deposition. In a second step, the fibers used as template are removed by pyrolysis or extraction. In this way, for example, nanotubes of poly-p-xylylene have been produced. By coating of the template fibers by spin-coating, nanotubes can be produced from a large number of polymers. Such a process for the production of hollow fibers is for example described by DE 100 23 456 A1.

Both of the known template processes are relatively costly, since they either require a polymerization step within the template or a gas phase deposition step onto the template. In addition, the processes are limited to certain starting materials.

Consequently, one task of the present invention was to provide a process for the production of hollow fibers, in particular of meso- and nanotubes, wherein the disadvantages of the state of technology are at least partially avoided. The process should further make it possible to process a large number of materials, and to regulate the properties of the resulting hollow fibers in a controlled manner, for example in terms of shape and size, material composition, morphology, structuring and the controlled, regular arrangement of hollow fibers with lateral extents up to within the square centimeter range.

The task is solved by a process for the production of hollow fibers of nonpolymeric materials with external diameters from 10 nm to 100 μm, preferably 10 nm to 50 μm, which contain at least one polymer, comprising the steps:
(a) provision of a porous template material,
(b) introduction of a liquid containing at least one polymer into pores of the template material in such a manner that the pore walls are wetted by the liquid, but the pores are not filled completely with liquid,
(c) solidification of the liquid and
(d) optionally at least partial removal of the template material.

A further object of the invention is a process for the production of hollow fibers of non-polymeric materials with external diameters from 10 nm to 100 μm, comprising the steps:
(a) provision of a porous template material,
(b) introduction of a liquid which contains at least one polymer and at least one nonpolymeric material into the pores of a template material in such a manner that the pore walls are wetted by the liquid, but complete filling of the pores does not take place,
(c) solidification of the liquid,
(d) selective, at least partial removal of the polymeric components, for example by thermal, chemical, photochemical or/and biological processes, by extraction with a selective solvent, the action of radiation, plasma or/and ultrasound,
(e) optionally chemical transformation of the nonpolymeric material remaining in the pores and
(f) optionally at least partial removal of the template material.

A still further object of the invention are hybrid materials containing hollow fibers, which are obtainable by solidification of the polymer-containing liquid in the pores of the template material and the hollow fibers obtainable by at least partial removal of the template material, which are preferably essentially free of template material. The hollow fibers can optionally have several polymer components in predetermined mixing ratios or/and regions of differing material composition. If mixtures which contain selectively removable polymers and non-polymeric material are used for the wetting of the template, nanotubes of the nonpolymeric material are producible by removal of the polymers. This can optionally be chemically transformed. Preferably, such nanotubes contain transition metals or oxides thereof as the wall material. Further, the hollow fibers can have structured, porous or/and incomplete, for example grooved surfaces.

A still further object of the invention are arrays of hollow fibers, characterized in that several hollow fibers are arrayed in parallel, in particular regular arrays of hollow fibers, preferably in hexagonal, trigonal or square lattices or graphite lattices, especially preferably over lateral ranges from 1 μm² to 500 cm², in particular from 25 mm² to 10 cm².

An advantage of the process according to the invention consists in that therewith both functionalized and also non-functionalized polymers can be used for the production of hollow fibers. It is even possible to use polymers which have additives, polymer mixtures and polymers with special molecular architectures, such as for example block copolymers, dendrimers, graft copolymers or polymer brushes.

A further advantage of the invention is that mixtures which contain polymers and non-polymeric materials can be used, wherein after at least partial selective removal of the polymers the nonpolymeric materials or reaction products formed therefrom form the walls of the nanotubes. Examples of nonpolymeric materials are metal-containing compounds, such as for example metal salts, e.g. compounds of platinum, palladium, nickel, silver, ruthenium, manganese, titanium, chromium or another transition metal or combinations of different transition metals.

The properties of the materials used for the production of the hollow fibers, in particular the material composition, mixing ratios for liquid materials consisting of at least two substances, and the magnitude of the average molecular weight and the shape of the molecular weight distribution for polymers, are freely selectable within broad limits in the use of the process according to the invention. A further advantage consists in that no costly polymerization step or gas deposition step onto the template is necessary. A still further advantage is that the properties of the hollow fibers are controllable over a wide range, preferably through deliberately induced phase transitions. If the liquid material contains crystalline or partially crystalline polymers, the degree of crystallinity of the hollow fibers can be adjusted by the choice of suitable process parameters. In the case of the processing of material mixtures, binodal or spinodal segregation morphologies can be deliberately produced in the filled templates by the induction of thermally induced phase separation processes and maturation times of differing lengths. Furthermore, phase transitions can be induced by alteration of the composition of the liquid material, preferably by evaporation of a volatile component. Such structured hollow fibers can be further functionalized. For example, from hollow fibers in which phase separation into amorphous and crystalline regions or/and regions of different material composition are present, individual phases can be selectively removed, or selectively crosslinked. If there are substances in the wall material which contain metal atoms or ions, for example salts or organometallic precursor compounds, these can be converted into the metals by means of suitable methods, for example by reduction or/and pyrolysis.

The hollow fibers can also have structured surfaces and a cylindrical or other cross section, depending on the template used. The process is particularly suitable for the production of hollow fibers which have a high surface/volume ratio, which is for example of great interest for applications in the catalysis field or for storage media, of hollow fibers with specific wetting and adhesion properties or of hollow fibers with regions of differing material composition and hollow fibers whose properties are modified by low molecular weight additives.

The wetting of high energy surfaces by materials with lower surface energy, which in general include organic substances and polymers (S. Wu, Polymer Interface and Adhesion, Marcel Dekker, New York (1982), Chapter 6, 215 ff), is in principle known. Thus, in the spreading of liquid drops on flat high energy surfaces, films with thicknesses in the submicrometer range, so-called precursor films, are formed. This phenomenon has been described by several authors even for the case of viscous, non-volatile liquids (P. G. de Gennes in Rev. Mod. Phys. 57 (1985), 827 and D. Ausseré, A. M. Picard and L. Léger in Phys. Rev. Lett. 57 (1986), 2671).

The mechanism of the wetting of substrate surfaces, during which the films are formed, has been studied on model systems. Thus, the wetting of smooth silicon wafers by polydimethyl-siloxane (PDMS) has been studied by L. Léger, M. Erman, A. M. Guinet-Picard, D. Ausseréand C. Strazielle (Phys. Rev. Lett. 60 (1988), 2390) and by E. Pérez, E. Schäffer and U. Steiner (J. Coll. Interface Sci. 234 (2001), 178). It was shown that homogenous films of high molecular weight PDMS form on the wafer surface even at room temperature.

The dynamics of the wetting of cylindrical capillaries by low viscosity, low molecular weight liquids has been studied in a model system on the basis of the penetration of water in porous glasses of cross-linked sponge-like structure, e.g. by M. G. Bernadiner in Transport in Porous Media 30 (1998), 251. In the case of capillaries with an internal diameter of 100 μm, a thin film of water first flows along the pore walls. Only when the walls have been completely wetted does the capillary itself begin to fill, starting from instabilities in the wetted film.

However, from these findings in the state of the technology it could in no way be deduced that viscous polymer-containing liquids penetrate into porous template materials in such a way that at least over a large region of the template material a wetting of the walls takes place without simultaneous complete filling of the pores. Thus it was surprising that on introduction of a polymer-containing liquid into a porous template material the pores first become wetted with a thin film, and the processes of wall-wetting and the complete filling of the pores can be chronologically separated. In order to prevent the complete filling of pores, the liquid source can be removed or/and the filling process interrupted for example by thermal quenching, e.g. cooling or evaporation of solvents.

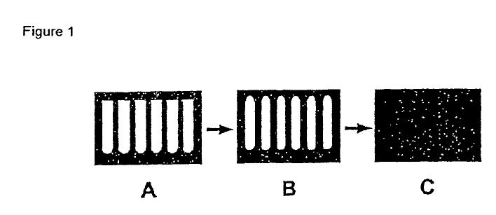

FIG. 1 shows snapshots of such a wetting process. It can be discerned that during the penetration of the liquid into the pores, firstly a thin film is formed, which covers the surface. Depending on the material and on the material properties, the thickness of the film can reach less than 100 nm, indeed right down to a few Angstroms in the molecular monolayer range. The film thickness is particularly dependent on the interactions between the film-forming liquid and the surface substrate. Preferably, therefore, combinations of liquid and substrate which have a contact angle close to zero are used. The pore walls are then very rapidly completely wetted.

The process according to the invention is characterized in that the pores of a template are wetted by a liquid material which contains at least one polymer and the liquid material is solidified after the wetting. In a preferred embodiment of the process according to the invention, the solidification includes the passage of at least one polymer component contained in the liquid through the glass transition. In a further preferred embodiment, the solidification includes a crystallization, when the liquid contains at least one polymer component capable of crystallization. Crystallization can be induced for example by a change in the material composition of the liquid material, for example by evaporation of a solvent, or/and by a temperature alteration.

The template material is a substance which contains pores. Preferably, the template has parallel or almost parallel-arrayed pores. Particularly preferred are templates with parallel-arrayed pores, whose diameter is essentially uniform over the whole pore length. The aspect ratio of the pores is preferably 1 to 20,000, especially preferably from 10 to 20,000 and quite especially preferably from 1,000 to 20,000. Herein, the aspect ratio is the quotient of the length of the pores divided by the average width (mean internal diameter) of the pores.

Templates are used which have pores with an average pore width from 10 nm to 100 μm, preferably from 10 nm to 50 μm, especially preferably from 10 nm to 5 μm and quite especially preferably from 50 nm to 1 μm. In order to be able to produce hollow fibers with almost equal dimensions, the template used preferably has pores which display a deviation from the average pore width of <5%, especially preferably <2% and quite especially preferably <1%.

For the process, templates in which the arrangement of the pores displays short-range order, and especially preferably templates in which the arrangement of the pores displays short-range order and long-range order, are used.

By means of the process according to the invention, hollow fibers which have a wall thickness <1 μm, preferably from 1 nm to 1 μm, especially preferably from 5 nm to 500 nm and quite especially preferably from 10 nm to 100 nm, are preferably produced.

Before the wetting of the template with the polymer-containing liquid, it can be advantageous if the template is cleaned. This can be effected in a manner known to the skilled person. Thus, a cleaning can be effected by contacting the template material with a suitable cleaning agent, for example by means of an acid, a base, an organic solvent, water or combinations thereof, with the proviso that the template itself is not destroyed by the cleaning agents used.

Porous solid substances based on organic or/and inorganic materials, such as for example porous organic polymer membranes, porous metal oxides, porous ceramics, porous metals or metalloids and porous semiconductors are suitable as template materials. Especially preferably, templates of porous aluminum oxide or porous silicon are used, the templates preferably fulfilling the aforesaid conditions with regard to pore size.

The production of suitable templates is known for example from microsystem technology, semiconductor technology and metal oxide alloying. With standard processes, such as for example plasma etching, templates can be produced which have pores with an aspect ratio of <50. Examples of commercially available materials which are suitable as templates are porous aluminum oxide or polycarbonate membranes. These usually display pore diameters from 10 nm to 250 nm.

Particularly suitable as templates are porous aluminum oxide materials which have been produced by self-organization. The electrochemical production of suitable porous aluminum oxide by self-organization with pore diameters from 10 nm to 400 nm is for example described by H. Masuda and K. Fukuda (Science, 268 (1995), 1466). The deviation in the average pore diameter here is less than 10%. Porous aluminum oxide materials which are suitable as templates are also accessible by techniques such as for example nanoindentation (H. Masuda et al., Appl. Phys. Lett. 71 (1997), 2770) or electron beam lithography (A. P. Li et al., Electrochem. Sol.-State Lett. 3 (2000), 131).

Also suitable are templates based on porous silicon, which can for example be produced by electrochemical etching of silicon. Their production is for example described in U.S. Pat. No. 4,874,484. In this way, regular templates with very smooth pore walls, the pores having a perfect cylindrical shape, are obtained. The pores of the preferred types of silicon templates have diameters from 200 nm to 10 μm. It can be advantageous to oxidize silicon templates thermally during their production, so that a 5 nm to 20 nm thick silicon oxide layer forms the pore wall. In this way, the surface can be made high-energy and hence the adhesion of liquid materials be improved. Moreover, the pore surfaces are smoothed by the thermal oxidation.

Depending on the shape of the template pores, hollow fibers with a great variety of external shapes or cross sections can be produced. Pores with shapes that depart from the cylindrical shape can also be produced (H. Masuda, H. Asoh, M. Watanabe, K. Nishio, M. Nakao, T. Tamamura, Adv. Mater. 13 (2001), 189). If the templates have pores with triangular, quadrilateral, pentagonal or hexagonal cross section or with any other polygonal or otherwise shaped cross sections, then with the process according to the invention, hollow fibers can be produced which have an external shape corresponding to the cross section. Template structures which, starting from the main pores, have defect pores or connecting pores between the main pores are also producible. The defect pores are reproduced during the production of the hollow fibers. In this way, hollow fibers with specific surface topologies can be produced.

In a preferred embodiment, templates, for example silicon templates which have defect pores starting from the main pores, whose diameter is smaller than that of the main pores, are used. Preferably, after the removal of the template material, hollow fibers with a surface which display knob-like elevations with structures in the region of 100 nm are obtained. Such hollow fibers have an increased surface/volume ratio, which is advantageous for a large number of applications. Moreover, modified tack, adsorption, adhesion or/and wetting properties are seen.

In another preferred embodiment, templates, for example silicon templates, which have connecting pores going from the main pores to other main pores, whose diameter is preferably less than that of the main pores are used. The resulting hollow fiber arrays after the removal of the template material are characterized in that the hollow fibers are linked together by reproductions of the connecting pores. These linkages stabilize the fiber array and are particularly advantageous in the case of free-standing hollow fiber membranes.

The liquid can be introduced into the template material as a polymer-containing melt, for example as a melt of a polymer or of a mixture of several polymers, which optionally contain further additives. The melt can be produced by heating of the material to a temperature above the solidification temperature of the polymer or of the polymer mixture. Quite especially preferably, the melt is produced by heating of the material to a temperature which lies at least 2%, preferably at least 10% and quite especially preferably 30%, above the solidification temperature of the polymer or of the polymer mixture.

For example, films, powders or granules of a polymer, e.g. polystyrene powder, can be placed on the upper side of a porous template. This arrangement is brought to a temperature above the glass transition temperature of polystyrene and for a certain time the polymer is allowed to flow into the pores, and in the process the pore walls are wetted. Before the pores themselves become filled with the polymer, the arrangement is chilled, for example to room temperature. It is also possible to melt the powder of the polymer, so that a liquid material is formed, and to dip the template with the pore surface into the liquid material. Here also, owing to the reduction in the surface energy, a wetting of the pore walls takes place.

The solidification of the liquid can be achieved by cooling of the melt. The solidification of the liquid material is preferably achieved by cooling to temperatures below 50° C., preferably below 30° C. and quite especially preferably by cooling or quenching to room temperature. Usually, the whole template with the liquid material which wets the walls of the pores is cooled or quenched. In the case of partially crystalline polymers, the degree of crystallization can be adjusted by the selection of suitable cooling rates and by tempering of the filled templates at a temperature above the glass transition temperature and below the melting temperature.

Alternatively, the polymer-containing liquid can also be introduced into the template material as a solution, suspension or/and emulsion of a polymer or a mixture of polymers, which can optionally further contain additives, in a carrier or carrier mixture, the polymer-containing liquid preferably being in the form of a solution. Suitable as carriers are substances which dissolve, suspend or emulsify the polymer or the polymer mixture and if relevant the additives, without the materials used being destroyed. Examples of carriers are organic solvents such as ethanol, dichloromethane, acetone, etc., and water, and mixtures thereof. The template with the porous surface can be dipped into this liquid or the solution can be dripped onto it. In the process, the pore walls are wetted by the liquid material. Wetting of the pore internal walls takes place even when liquid is dripped onto a rapidly rotating template.

In this embodiment of the process according to the invention, the liquid material can be solidified by removal of the carrier. It can be advantageous to sustain the evaporation by the use of increased temperatures. During the introduction of the liquid into the template, ultrasound can be used. This results in additional structuring of the fibers.

As described above, the complete filling of the pores with the liquid material after the wetting of the walls of the pores must be prevented. For this purpose, after a predetermined time period, after which adequate wetting of the walls of the pores has taken place, the source of the liquid material must be removed. This for example can be achieved by taking the template out of the liquid or by converting the liquid medium into the solid state, e.g. by solidification of the melt or/and removal of the carrier.

The polymer present in the liquid material has for example a number averaged molecular weight (Mn) of more than 500 D, in particular more than 5,000 D, preferably more than 50,000 D, especially preferably more than 100,000 D, still more preferably more than 500,000 D and most preferably more than 1,000,000 D. It can be selected from:
(i) organic polymers, such as poly(p-xylylene), polyether imides, polyaryl ether ketones, polysulfones, poly(phenylene sulfides), polyacrylamides, polyimides, polyesters, polyolefins, polystyrenes, polycarbonates, polyamides, polyethers, polyphenylenes, polysilanes, polysiloxanes, polybenzimidazoles, polybenzthiazoles, polyoxazoles, polysulfides, polyester amides, polyarylenevinylenes, polylactides, polyether ketones, polyurethanes, polysulfones, ormocers, polyacrylates, silicones, fully aromatic copolyesters, poly-N-vinylpyrrolidone, polymethacrylates, e.g. polyhydroxymethyl methacrylate or polymethyl methacrylate, polyterephthalates, such as polyethylene terephthalate or polybutylene terephthalate, polymethacrylonitriles, polyacrylonitriles, polyvinyl acetates, neoprene, buna N, polybutadiene, or halogenated polyolefins, e.g. polyvinylidene fluoride or polytetrafluoroethene, and dendrimers,
(ii) biological polymers, such as polysaccharides, e.g. cellulose (modified or unmodified) or alginates or polypeptides, e.g. collagen,
(iii) polymers made up of two or several different repeating units, preferably in the form of block copolymers, graft copolymers or dendrimers, and homo- and copolymers or/and mixtures thereof.

Especially preferably, the liquid material according to the invention contains a polymer selected from polystyrenes, polyamides or polymethyl methacrylates.

Polymers with special architectures, such as for example block copolymers, dendrimers or graft copolymers, polymer brushes or/and polymers containing mesogens can also be used.

Through the introduction of the liquid material into the template and the subsequent solidification, a template with pores whose walls are coated with a polymer-containing material is firstly obtained. If the polymer-containing coating contains nonpolymeric materials, the polymeric components can be at least partially selectively removed, so that a hybrid structure results, which is characterized by pore walls coated with the nonpolymeric material. This nonpolymeric material can be further transformed chemically. An example of this is the introduction of a mixture of a thermally degradable polymer and a metal-containing compound which is preferably selected from components which
(i) contain a metal, in particular platinum, palladium, gold, silver, nickel, rhodium, ruthenium, manganese, titanium or chromium, another main group or transition metal or combinations of different metals,
(ii) contain an organometallic compound or another metal-containing compound, in particular platinum, palladium, gold, silver, nickel, rhodium, ruthenium, manganese, titanium or chromium, another main group or transition metal or combinations of different metals,
(iii) are semiconductor materials,
(iv) alloys of semiconductor materials and/or
(v) precursor compounds for semiconductor materials.

The metal-containing compound can then be transformed by suitable methods, for example metal-containing compounds, e.g. organometallic compounds, can be converted into metals or metal oxides, or semiconductor precursor compounds can be converted into semiconductor compounds. If a transition metal precursor is used as the metallic compound, the polymer can be removed by pyrolysis of the filled template or in another way and the transition metal converted into the metallic state. An array of metal-coated microcavities results. Such hybrid structures are suitable for a range of applications, for example as a microcell array in combinatorial materials and active substance research or as a photonic crystal. The hybrid structures preferably contain uniform pores with a size that deviates from the average pore size by less than 5%, especially preferably less than 1%. A regular array of the pores, for example in a hexagonal, trigonal or square lattice or in a graphite lattice can particularly advantageous here, for example for the ability to control individual pores.

The process according to the invention is particularly suitable for the processing of materials which are liquid in the melt or in solution or emulsion and are converted into a solid state by suitable measures. These also include materials and material mixtures whose properties can be deliberately adjusted during or/and after the wetting of the pores of the template. This can for example occur by induction of a phase transition. A phase transition can for example be induced by alteration of the material composition of the liquid material, preferably by evaporation of a volatile component. A particularly advantageous method is the induction of a phase transition by means of a temperature change. In this case, the process can be precisely controlled by control of the process temperature. A phase transition can for example take place in the form of conversion of a homogenous material into a state in which regions of differing material composition are present. Likewise, amorphous and crystalline regions can be formed from a homogenous material. Phase transitions can however also concern changes in electrical or magnetic material properties. If the liquid material is a material mixture, a phase transition can also manifest itself in an altered wetting behavior with regard to the pore wall material.

Hollow fibers with porous surfaces or fibers whose internal space is not completely surrounded by a surface, such as for example grooved fibers, have advantageous properties, for example an increased surface/volume ratio. For the production of such products, a material mixture which is subjected to a phase separation process is used as the liquid material. As a result of this, regions of differing material composition are created in the surfaces. An embodiment which results in a spinodal segregation process is preferred. If segregation takes place in a phase consisting of a nonvolatile material and a volatile material, pores are for example formed from the regions in which the volatile material was present, after the disappearance of this. The non-volatile material can for example contain a polymer, and the volatile material for example a low molecular weight carrier. If two coexisting phases, each of nonvolatile material, are present, where at least one phase contains at least one polymer, one of these phases can be selectively removed. This can preferably take place thermally, chemically, biologically, induced by radiation, photochemically, by plasma, ultrasound, microwaves and/or extraction with a solvent.

If the liquid material is left for a selected period in a state wherein coexisting phases are present, and wherein the material is mobile, maturation of the morphology can take place. In the case of spinodal segregation, directly after the onset of the segregation a state can be present wherein both coexisting phases have interfaces to the pore wall and form a fine inter-penetrating morphology. After a predetermined maturation time, a situation can have arisen wherein for example a dished morphology is present similarly to an interface-oriented spinodal segregation. The maturation process can be frozen in at a selected time point, for example by a temperature alteration. As well as a further functionalization, for example by selective removal of a phase, this is also an advantageous method of producing hybrid fibers. An example of such hybrid hollow fibers are hollow fibers whose internal surface consists of a chemically resistant material and whose outer surface consists of a mechanically stable material.

In order to be able to use the hollow fibers or nano- or mesotubes without the template, the template must be at least partially selectively removed after the solidification of the liquid material. The removal of the template can take place thermally, chemically, biologically, induced by radiation, photochemically, by means of plasma, ultrasound, microwaves or/and extraction with a solvent. Preferably, the removal of the template takes place by chemical or/and thermal means, for example by treatment with acidic or alkaline etching solutions, optionally with warming. If aluminum oxide or silicon is used as the template, the removal of the template is effected for example with an aqueous alkali solution, preferably with an aqueous potassium hydroxide solution or an acid, preferably H₃PO₄ for aluminum oxide or HF/HNO₃ mixtures for silicon.

Depending on the implementation of the process according to the invention, non-ordered or ordered hollow fibers or hollow fiber arrays are obtainable. The hollow fibers can be sealed at both ends, at one end, or be open at both ends. Thus, hollow fibers produced according to the invention can be used for the production of nonwoven or woven textiles.

Hollow fiber arrays are obtained on account of adhesive forces between the individual hollow fibers. It can be advantageous if the hollow fibers of the individual pores are linked together via polymeric material, where the linking polymer material can be residues of the polymer applied to the template, melted and then solidified, or can result from the filling of the linking pores situated between the main pores of the template. Hollow fiber arrays with long range order predefined by the template with a lateral extent up to the region of several square centimeters can be produced. Arrays of hollow fibers present nanostructured surfaces. Such surfaces display specific tack properties (K. Autumn, Y. A. Liang, S. T. Hsieh, W. Zesch, W. P. Chan, T. W. Kenny, R. Fearing, R. J. Full, Nature 405 (2000), 681) and specific wetting properties (W. Chen, A. Y. Fadeev, M. C. Hsieh, D. Öner, J. P. Youngblood, T. J. McCarthy, Langmuir 15 (1999), 7238).

Likewise, hollow fibers or arrays of hollow fibers according to the invention or produced according to the invention can be used as components in medical devices, for example artificial lungs, in microelectronics as wire, cable or capacity, as waveguides, in superlight construction technology, in medical separation technology, in capillary electrophoresis, in scanning probe microscopy, in catalytic systems, in fuel cells, in batteries or in electrochemical reactors.

In addition, hollow fibers or arrays of hollow fibers according to the invention or produced according to the invention are suitable for use as sensor components, as microreactors, as protein storage, as drug delivery systems, as composite materials, as fillers, as mechanical reinforcement, as heat insulators, as dielectrics, as interlayer dielectrics in chip manufacture, as separation media, as storage media for gases, liquids or particle suspensions or as materials in the clothing industry.

In the clothing/textile industry, the hollow fibers according to the invention can be used as heat insulators in clothing or sleeping-bags, in photo- or thermochromic clothing through embedding of dyes within the tubes or as identifiers by means of markers within the tubes.

The invention is explained in more detail by means of the following figures and examples, without it being intended to limit it to these embodiments.

FIG. 1 shows the different stages of the wetting of porous templates. FIG. 1A shows a template on the upper side of which liquid polymer is present. In FIG. 1B, it can be discerned that the polymer liquid has wetted the walls of the pores. FIG. 1C shows the state wherein the polymer liquid entirely fills the pores. The state shown in FIG. 1c occurs when the liquid material has too much time to penetrate into the pores.

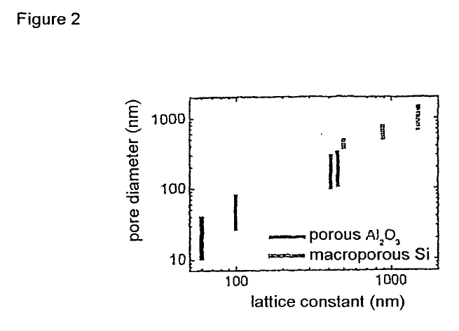

FIG. 2 shows in graph form what highly ordered pore structure pore diameters are accessible at what lattice constants. The lattice constant is plotted on the x-axis, and the pore diameter on the y-axis.

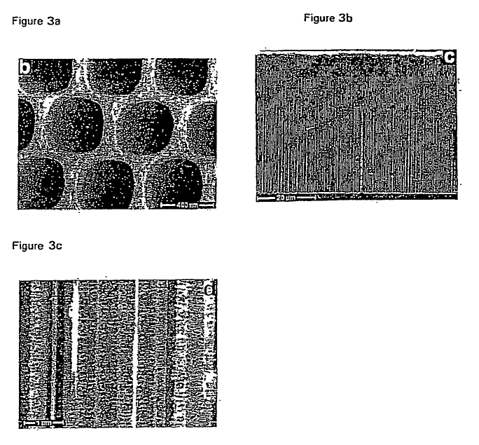

FIG. 3a shows a porous silicon template, wherein the pores are arrayed hexagonally. FIG. 3b shows a section through such a porous template. FIG. 3c shows macroporous silicon, the main pores of which display defect pores.

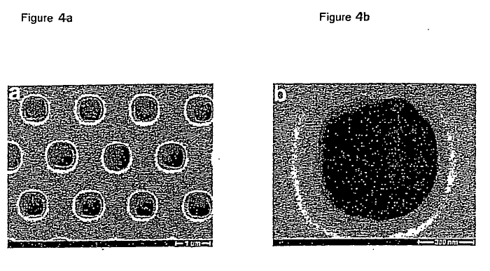

FIG. 4 shows a macroporous silicon template (pore diameter 700 nm, pore length 100 μm), which had been filled with polymethyl methacrylate (PMMA 40,000 D). FIG. 4a shows a larger region, and FIG. 4b a single pore. It can clearly be discerned that the polymer has wetted the pore walls with a film a few tens of nanometers thick.

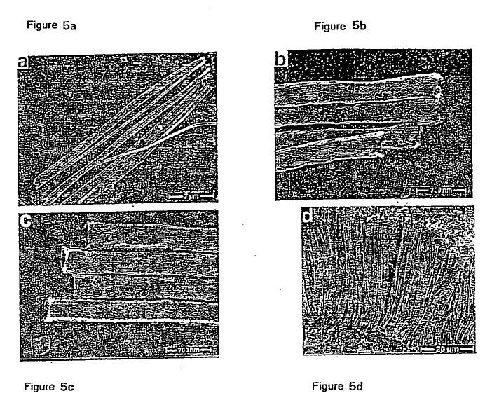

FIG. 5a shows a bundle of parallel aligned polystyrene (PS) hollow fibers (Mw=65,000 D, Mn=64,000 D; Mw/Mn=1.02) after the selective removal of the template. FIG. 5b and FIG. 5c each show the ends of the above four parallel arrayed hollow fibers enlarged. The hollow fibers from FIGS. 5a to 5c were produced from porous silicon by means of the template shown in FIG. 3b. FIG. 5d shows hollow fibers of the same material, which were obtained using a commercially obtainable aluminum oxide template (Whatman Anopore, diameter of ca. 200 nm, depth of 50 μm). The aspect ratio of the hollow fibers reproduces that of the template pores and is 250.

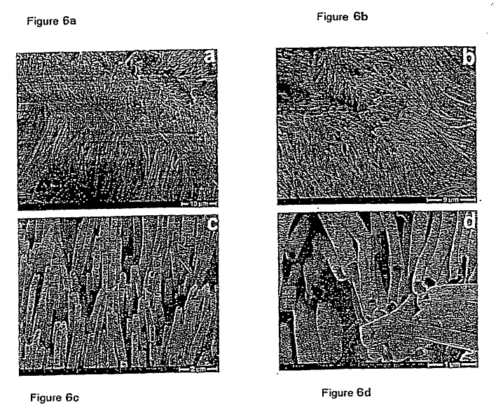

FIG. 6 shows four pictures a to d of hollow fibers of PMMA (Mw=40,300 D) at different magnifications after the selective removal of the template. The aluminum oxide template (Whatman Anopore) had pores with a diameter of ca. 200 nm and a depth of 50 μm. The aspect ratio of the hollow fibers is 250.

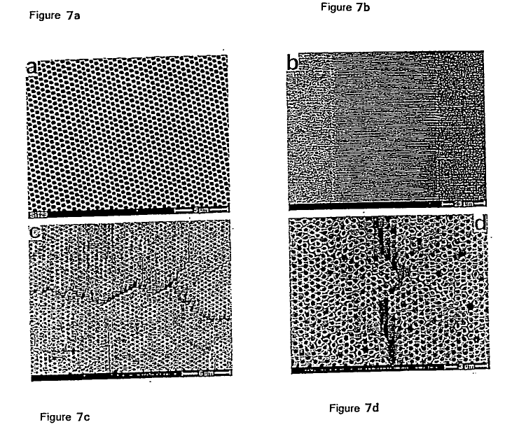

FIGS. 7b-d show scanning electron micrographs of arrays of hollow fibers of PMMA (Mw=40,300 D) after the selective removal of a template which is shown in

FIG. 7a before filling. In the overall picture 7b, fibers which were produced from regions of the template in which the pore array was irregular can be seen on the left and right edges of the picture. The regular hexagonal array of the template is largely reproduced in the middle region. 7c and 7d show details.

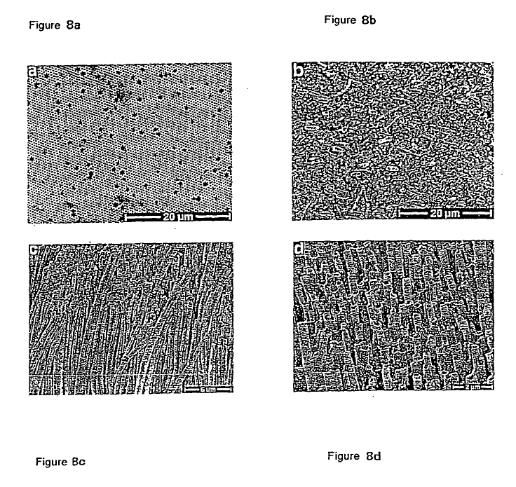

FIGS. 8b-d show an array of hollow fibers with a bimodal diameter distribution, which was obtained by the use of the silicon template shown in FIG. 8a with larger defect pores, after the selective removal of the template.

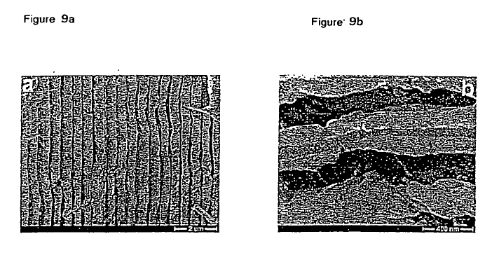

FIG. 9 shows hollow fibers of polyvinylidene fluoride PVDF (Mn=38,000 D, Mw=100,000 D; Tm=178° C.), which were obtained by introduction of the PVDF at 200° C. into macroporous silicon. The template was partially selectively removed. FIG. 9a shows a fracture edge with PVDF hollow fibers embedded in not yet removed template. FIG. 9b shows a cut-open PVDF hollow fiber.

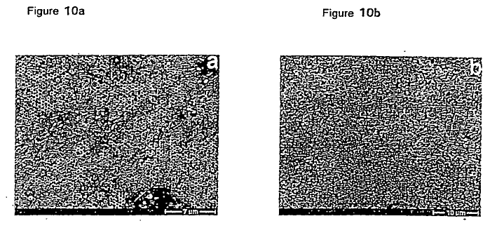

FIG. 10 shows hollow fibers of 5:1 PMMA (80,000 D)/PS (500,000 D), which were obtained by dripping a solution in dichloromethane onto macroporous silicon. The upper end of the fibers is open (a), the lower end closed (b).

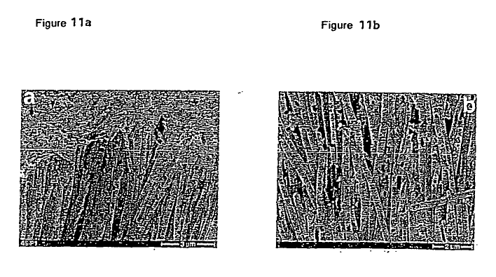

FIG. 11 shows porous hollow fibers of polystyrene with a molecular weight of 500,000 D after the selective removal of the template. These were obtained by dripping a 2.4% polystyrene solution in dichloromethane onto an aluminum oxide membrane (Whatman Anodisc, diameter ca. 200 nm, pore depth 50 μm)

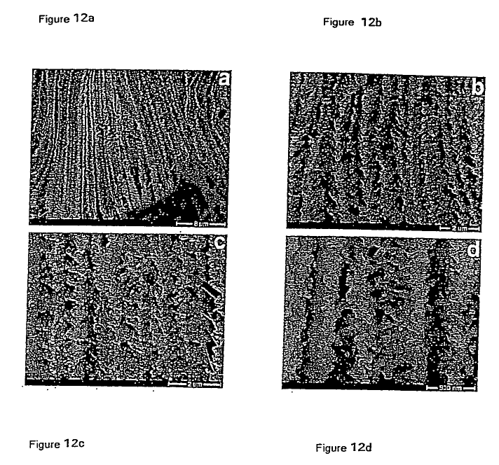

FIG. 12 shows polymer hollow fibers after the selective removal of the template. These were obtained by dripping a mixture of 83% PMMA (80,000 D) and 17% polystyrene (150,000 D) dissolved in dichloromethane onto macroporous silicon, as illustrated in FIG. 3c. By reproduction of the defect pores, which start from main pores, hollow fibers with a rough or knobbly surface were obtained.

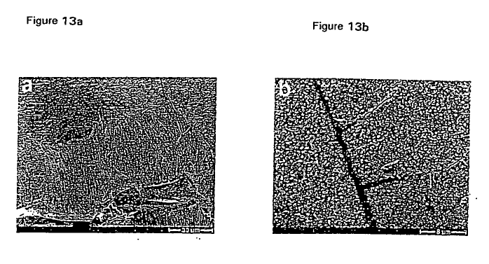

FIG. 13 shows hollow fibers which were obtained by dripping a solution of 7:3 polystyrene (8,000 D):polymethyl methacrylate (3,400 D) onto a template rotating at 3,000 RPM (aluminum oxide Whatman Anodisc, pore diameter ca. 200 nm, pore depth 50 μm) The template was then selectively removed.

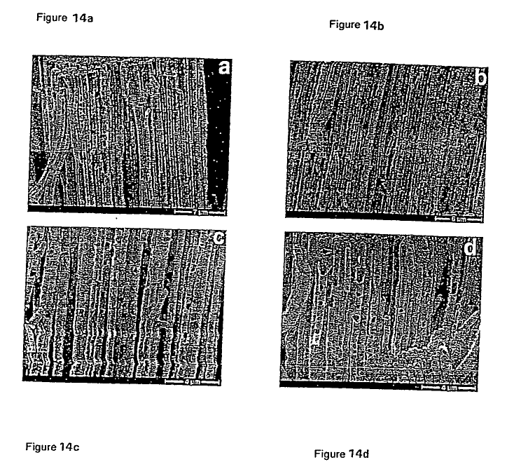

FIGS. 14a-d show hollow fibers of 5:1 PMMA (80,000 D)/PS (500,000 D), which were obtained by dripping of a solution in dichloromethane onto macroporous silicon under the action of ultrasound, after the selective removal of the template. These hollow fibers display pores or undulations of the wall thickness.

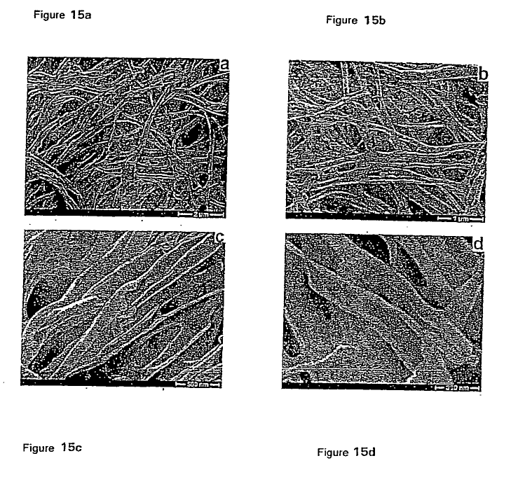

FIG. 15 shows grooved residual fibers of PMMA (800,000 D). These were obtained by dripping of a homogenous solution of 5:1 polyethylene oxide (900,000 D)/PMMA (800,000 D) in dichloromethane onto an aluminum oxide membrane (Whatman Anodisc, pore diameter ca. 200 nm, pore depth 50 μm) . The filled template was tempered for 23 hrs at 200° C. and then cooled at a rate of 150 K/min. Then firstly the template and then polyethylene oxide were selectively removed with water.

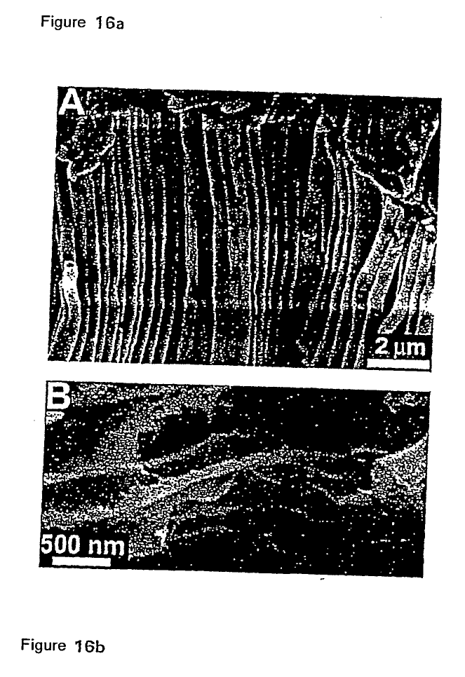

FIG. 16 shows scanning electron micrographs of polytetrafluoroethylene nanotubes. An array of PTFE hollow fibers is shown in FIG. 16a. A cross section along the tube axis of a PTFE fiber can be discerned in FIG. 16b.

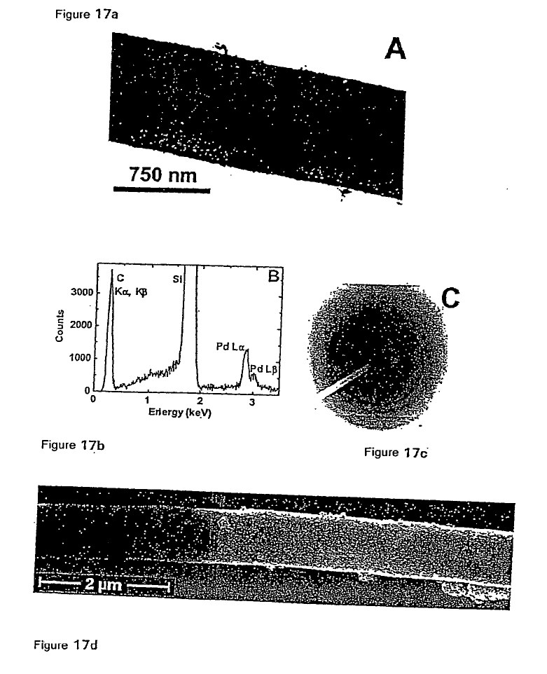

FIG. 17a shows a transmission electron micrograph of a polystyrene/palladium composite fiber, taken with an acceleration potential of 1 MeV. FIG. 17b shows an energy dispersive X-ray microanalysis of a single composite fiber on a silicon substrate, in which palladium can be detected. FIG. 17c shows electron diffraction patterns of a single composite fiber, which derive from palladium crystals, whose size was estimated at 2 nm by the Debye-Scherrer method. FIG. 17d shows an SEM micrograph of a composite fiber which was treated with ultrasound for 30 mins, so that part of the outer Pd layer was removed, and the morphology of the composite fibers, consisting of an inner PS layer (darker region of the nanotube on left in picture) and an outer Pd layer (lighter region on right in picture) became visible.

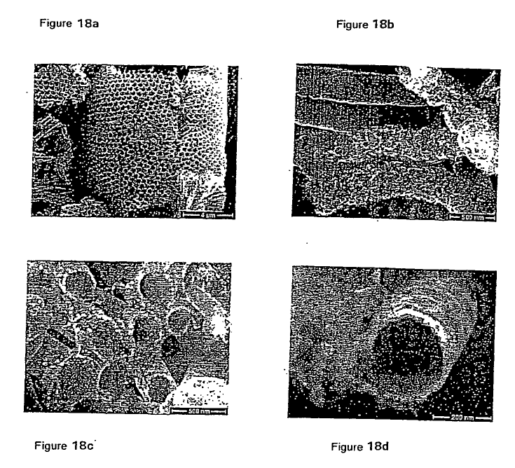

FIG. 18 shows scanning electron micrographs of palladium nanotubes with differing morphologies, which were obtained by wetting of the pores of an aluminum oxide template with a mixture of palladium acetate, polylactide and dichloromethane and subsequent pyrolysis in accordance with Example 15. FIG. 18a shows an array of Pd nanotubes. FIG. 18b shows Pd nanotubes with a rough net-like morphology and a smooth porous morphology, and FIGS. 18c and 18d cross sections through Pd nanotubes.

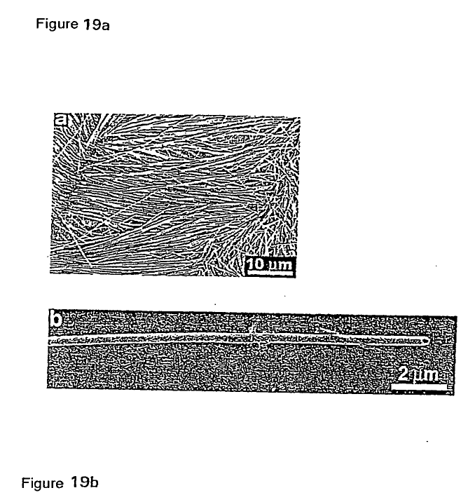

FIG. 19 shows polyether ether ketones (PEEK) nanotubes FIG. 19a shows an array of PEEK nanotubes, while in FIG. 19b a single PEEK nanotube with aperture can be discerned.

### EXAMPLE 1

### Production of a Silicon Template

A pattern was applied onto an n-type silicon wafer with <100> orientation by standard photo-lithography. Reverse pyramidal holes on the surface, which act as starting pores, were obtained by alkaline etching. Under anodic conditions and back illumination, the wafer was then etched with hydrofluoric acid. The electronic holes which were formed in the region of the back surface because of the back illumination spread through the whole wafer and cause the dissolution of the silicon at the points of the reverse pyramidal holes. A template which contains pores with a diameter of 700 nm and a pore length of 100 μm was obtained.

### EXAMPLE 2

### Coating of the Pore Walls of Macroporous Silicon with Polymethyl Methacrylate (PMMA)

For cleaning, a template of macroporous silicon (pore diameter 700 nm, pore length 100 μm) was cleaned with nitric acid for 24 hrs, then washed twice with deionized water and once with acetone and baked for 2 hrs at 200° C. in vacuo in a heating block. In a counterflow of argon, whose purpose was to prevent polymer and template from coming into contact with atmospheric oxygen and moisture, PMMA powder was applied onto the template. The PMMA was obtained from Polymer Standard Service, Mainz (Mw=40,300 D, Mn=38,100 D, D=1.06). A vacuum was again applied and the polymer maintained in the liquid state for 60 mins at 200° C., before being quenched to room temperature at a cooling rate of 8 K/sec. The filled template obtained was examined by scanning electron microscopy. The template produced according to Example 2 with PMMA-coated pore inner walls is shown in FIG. 4.

### EXAMPLE 3

### Production of Polystyrene (PS) Hollow Fibers by Introduction of Polystyrene Melts

Porous aluminum oxide templates (Whatman Anopore, diameter ca. 200 nm, depth 50 μm) were treated with deionized water, ethanol, chloroform and hexane in an ultrasound bath. Porous silicon templates (pore diameter 370 nm, pore depth 40 μm) were treated with nitric acid for several days and then washed with deionized water and acetone. The cleaned templates were heated to a temperature of 200° C. in vacuo on a heating block and baked at this temperature for 2 hrs. Polystyrene powder was placed on the upper sides of the heated templates. The polystyrene was obtained from Polymer Standard Service, Mainz (Mw=65,000 D, Mn=64,000 D, D=1.02). In order to avoid chemical destruction of the polymers, the application of the polymer was effected under argon as blanket gas. After this, the cell with heating block and templates was again placed under vacuum. At 200° C., the temperature was selected such that the glass transition temperature of the polystyrene used was markedly exceeded and the liquid polymers could penetrate into the pores. After 20 mins, the heating block with the template was quenched to room temperature within 20 secs. For the removal of the template, this was treated with an aqueous potassium hydroxide solution. Both with silicon and with aluminum oxide templates, polystyrene hollow fibers with a wall thickness of about 30 nm, which in each case exactly reproduced the shape of the pores were obtained. The nanotubes obtained were examined with a scanning electron microscope (SEM). The polystyrene hollow fibers produced according to Example 3 are shown in FIG. 5.

### EXAMPLE 4

### Production of Polymethyl Methacrylate (PMMA) Hollow Fibers by Introduction of PMMA Melts

The templates were cleaned and baked as described in Example 3. PMMA powder was placed on the upper sides of the heated templates under argon blanket gas. The PMMA was obtained from Polymer Standard Service, Mainz (Mw=40,300 D, Mn=38,100 D, D=1.06). After the application of the polymers, the cell with heating block and templates was again placed under vacuum. At 200° C., the temperature was selected such that the glass transition temperature of the PMMA used was markedly exceeded and the liquid polymer could penetrate into the pores. After preset time periods in each case, the heating block with the template was quenched to room temperature within 20 secs. For the removal of the template, this was treated with an aqueous potassium hydroxide solution. Both with silicon and also with aluminum oxide templates, PMMA hollow fibers with a wall thickness which varied from about 15 nm to 60 nm depending on the sample were obtained. In each case, the shape of the pores was exactly reproduced. The nanotubes obtained were examined with a scanning electron microscope (SEM).

In Example 4a, PMMA hollow fibers were obtained by the use of a commercially available aluminum oxide template with an aspect ratio of 250. In Example 4b, a monodomain of PMMA hollow fibers which reproduces the hexagonal arrangement of the pores in the template could be obtained. In Example 4c, a template which contained defect pores which have a markedly greater pore diameter than the great majority of the pores was used. After dissolution of the template, it was clearly seen that the hollow fibers have reproduced both the normal pores and also the defect pores with their external diameter. Hence it follows that with the process according to the invention hollow fibers with an external shape which corresponds to the shape of the pores of the template can be produced.

The conditions selected in Examples 4a-4c are shown in the following table:

| | | Pore | Pore | Duration of |
|---|---|---|---|---|
| Example | Template | diameter | length | introduction |
| Example | Porous | ca. 200 nm | 50 μm | 120 mins |
| 4a | aluminum | | | |
| | oxide | | | |
| | (Whatman | | | |
| | Anodisc). | | | |
| | Pores short- | | | |
| | range | | | |
| | ordered | | | |
| Example | Macroporous | 470 nm | 50 μm | 60 mins |
| 4b | silicon | | | |
| | Hexagonal | | | |
| | arrangement | | | |
| | of pores | | | |
| Example | Macroporous | 370 nm | 50 μm | 120 mins |
| 4c | silicon | and | | |
| | Hexagonal | ca. 1,000 nm | | |
| | arrangement | respectively | | |
| | of pores. | | | |
| | Irregular | | | |
| | defect pores | | | |
| | between | | | |
| | these. | | | |

The PMMA hollow fiber produced according to Example 4a are shown in FIG. 6, the PMMA hollow fibers produced according to Example 4b in FIG. 7, and the PMMA hollow fibers produced according to Example 4c in FIG. 8.

### EXAMPLE 5

### Production of Polyvinylidene Fluoride (PVDF) Hollow Fibers by Introduction of PVDF Melt into Porous Templates

Polyvinylidene fluoride PVDF 1008 (Solvay, Mn=38,000 D, Mw=100,000 D, D=2.6, n=1.42, Tg=−40° C., Tm=178° C.) was applied in granular form under an argon counterflow onto macroporous silicon which had been cleaned as described in Example 2. At a temperature of 210° C., which was markedly higher than the melting point of PVDF, PVDF was maintained liquid for 2 hrs, before quenching to room temperature. After the removal of the template with aqueous potassium hydroxide solution, PVDF hollow fibers were obtained. The nanotubes obtained were examined with a scanning electron microscope (SEM). The hollow fibers produced according to Example 5 are shown in FIG. 9.

A template filled as described above was cooled to 130° C. in the heating block in vacuo and tempered for 1 hr at this temperature. Xray experiments showed that the polymer was present in partially crystalline form and the crystallites were aligned. The lamellar crystals were aligned parallel to, or the individual chains in the lamellar crystals perpendicular to, the pore wall. This could be concluded from the fact that in the diffraction diagram only the 200 reflection was visible, i.e. only the 200 lattice plane contributed to the scattering.

### EXAMPLE 6

### Production of Hollow Fibers from a Polymer Mixture, Which are Closed on one Side and Open on One Side

A homogenous solution of a mixture of 83 wt. % of PMMA and 17 wt. % of PS in dichloro-methane was dripped onto a macroporous silicon template, which had blind pores as shown in FIG. 3b. PMMA from Polymer Standard Service was used (Mn=78,400 D, Mw=81,800 D, D=1.03) and PS from Fluka (Mn=500,000 D, Mw=490,000 D, D=1.03). The liquid material solidified by evaporation of the solvent. The template was examined with the scanning electron microscope, once from the side on which the pores of the template were closed and once from the opposite side, on which the pores of the template were open. The hollow fibers produced according to Example 6 are shown in FIG. 10.

### EXAMPLE 7

### Production of Porous Polystyrene (PS) Nanotubes

A 2.4 wt. % solution of PS (Fluka, Mn=500,000, Mw=490,000, D=1.03) in dichloro-methane was dripped onto an aluminum oxide membrane (Whatman Anodisc, pore diameter ca. 200 nm, pore length 50 μm). The polymer solidified through evaporation of the solvent. In this process, pores with diameters in the region of 100 nm were formed in the surface of the PS hollow fibers present in the template. The template was removed by treatment with aqueous potassium hydroxide solution. The nanotubes obtained, which contained pores with diameters of about 100 nm in their surface, were examined in a scanning electron microscope (SEM). The hollow fibers produced according to Example 7 are shown in FIG. 11.

### EXAMPLE 8

### Production of Hollow Fibers with Rough Surface

A homogenous solution of a mixture of 83 wt. % of PMMA and 17 wt. % of PS in dichloro-methane was dripped onto a macroporous silicon template, which had main pores whose surfaces contained defect pores, as shown in FIG. 3c. PMMA from Polymer Standard Service was used (Mn=78,400 D, Mw=81,800 D, D=1.03) and PS from Fluka (Mn=154,000 D, Mw=151,000 D, D=1.02). The liquid material solidified by evaporation of the solvent. The template was selectively removed with aqueous potassium hydroxide solution. The array of hollow fibers obtained contained hollow fibers whose surfaces displayed structures with dimensions in the region of 100 nm, which had formed by reproduction of the defect pores. The examination of the hollow fibers was performed with the scanning electron microscope. The hollow fibers produced according to Example 8 are shown in FIG. 12.

### EXAMPLE 9

### Production of Hollow Fibers by Introduction of the Liquid Material into a Rotating Template

A solution of PS (Polymer Standard Service Mn=7,800 D, Mw=8,100 D, Mw/Mn=1.05) and PMMA (Polymer Standard Service Mn=3,190 D, Mw=3,470 D, Mw/Mn=1.09) in the ratio 70:30 in dichloromethane was dripped onto an aluminum oxide membrane (Whatman Anodisc, pore diameter ca. 200 nm, pore length 50 μm), which was located on a Spincoater Convac TSR 48/6 and rotated at 3,000 RPM during the drip application. The polymer solidified on evaporation of the solvent. The template was removed by treatment with aqueous potassium hydroxide solution. Hollow fibers which possessed the same dimensions as the pores of the template were obtained. The nanotubes obtained were examined with a scanning electron microscope (SEM). The hollow fibers produced according to Example 9 are shown in FIG. 13.

### EXAMPLE 10

### Production of Hollow Fibers by Dropwise Addition of Polymer Solutions Under the Action of Ultrasound

A homogenous solution of a mixture of 83 wt. % of PMMA and 17 wt. % of PS in dichloro-methane was dripped onto a macroporous silicon template (diameter of the pores 470 nm, pore length 50 μm), during which the template was located in a Sonorex TK52H ultrasound bath, PMMA from Polymer Standard Service was used (Mn=78,400 D, Mw=81,800 D, D=1.03) and PS from Fluka (Mn=500,000 D, Mw=490,000 D, D=1.03). The liquid material solidified through evaporation of the solvent. During the drip addition and the subsequent 5 mins, ultrasound was applied to the template. The template was selectively removed with aqueous potassium hydroxide solution. The fibers obtained were examined with a scanning electron microscope (SEM). They displayed periodic undulations of the wall thickness, discernible from the contrast fluctuations in the SEM images and periodically occurring pores with diameters in the region of 100 nm. The hollow fibers produced according to Example 10 are shown in FIG. 14.

### EXAMPLE 11

### Production of Hollow Fibers with Regions of Differing Material Composition and Selective Removal of One of These Regions

A solution of polyethylene oxide (PEO, Acros, Lot A010886202, M=900,000) and PMMA (Polymer Standard Service Mp=903,000, Mn=721,000, Mw=790,000, D=1.10) in the ratio 5:1 in dichloromethane was dripped onto an aluminum oxide membrane (Whatman Anodisc, pore diameter ca. 200 nm, pore length 50 μm) . The polymer solidified through evaporation of the solvent. PEO is a water-soluble polymer and can therefore be selectively removed with water. The filled template was tempered at 200° C., i.e. above the solidification temperature of the components, for 23 hrs in a heating block and then quenched to room temperature at a rate of 150° C./min. During this procedure, a segregation process and segregation morphology maturation processes occurred. The template was removed by treatment with aqueous potassium hydroxide solution. Next the fibers were washed twice with water. During this procedure, the water-soluble PEO was completely dissolved. Grooved continuous PMMA residual fibers were obtained, which were examined with a scanning electron microscope (SEM). The hollow fibers produced according to Example 11 are shown in FIG. 15.

### EXAMPLE 12

### Production of Hollow Fibers from Polytetrafluoroethylene

Porous aluminum oxide templates with a pore diameter of 460 nm and a pore depth of 40 μm were treated with deionized water, ethanol, acetone, chloroform and hexane in an ultrasound bath. The cleaned templates were heated to a temperature of 350° C. in a heating block in vacuo and baked for 2 hrs at this temperature. Polytetrafluoroethylene powder was applied onto the upper sides of the heated templates. The polytetrafluoroethylene was obtained from Aldrich and according to the manufacturer had a melting point of 321° C. In order to avoid chemical destruction of the polymer, the application of the polymer was performed under argon as blanket gas. After the application of the polymer, the cell with heating block was again placed under vacuum. At 350° C., the temperature was selected such that the melting temperature of the polytetrafluoroethylene used was markedly exceeded and it could penetrate into the pores. After 30 mins, the heating block with the template was quenched to room temperature within 20 secs. For removal of the template, this was treated with an aqueous potassium hydroxide solution. Polytetrafluoroethylene hollow fibers with a wall thickness of about 30 nm, which in each case exactly reproduced the shape of the pores, were obtained. The nanotubes obtained were examined with a scanning electron microscope (SEM). The polytetrafluoroethylene hollow fibers produced according to Example 12 are shown in FIG. 16.

### EXAMPLE 13

### Production of Hollow Fibers from Polystyrene with a Molecular Weight of 800,000 D

Porous aluminum oxide templates with a pore diameter of 460 nm and a pore depth of 40 μm were treated with deionized water, ethanol, acetone, chloroform and hexane in an ultrasound bath. The cleaned templates were heated to a temperature of 235° C. in a heating block in vacuo and baked for 2 hrs at this temperature. Polystyrene powder was applied onto the upper sides of the heated templates. The polystyrene was obtained from Polymer Standard Service, Mainz (Mw=881,400 D, Mn=827,700 D, D=1.07). To avoid chemical destruction of the polymer, the application of the polymer was performed under argon as blanket gas. After the application of the polymer, the cell with heating block and templates was again placed under vacuum. At 235° C., the temperature was selected such that the glass transition temperature of the polystyrene used was markedly exceeded and it could penetrate into the pores. After 100 mins, the heating block with the template was quenched to room temperature within 20 secs. For removal of the template, this was treated with an aqueous potassium hydroxide solution. Polystyrene hollow fibers with a wall thickness of about 30 nm, which in each case exactly reproduced the shape of the pores, were obtained. The nanotubes obtained were examined with a scanning electron microscope (SEM).

### EXAMPLE 14

### Production of Pd-Functionalized Hollow Fibers

The process according to the invention can be used for the functionalization of hollow fibers. By way of example, the production of palladium/polymer composite hollow fibers, which are of importance for catalysis or hydrogen storage, is described here.

A silicon template (pore diameter 900 nm) was wetted at room temperature with a solution which contained equal parts by weight of poly-L-lactide (PLLA) and palladium-II acetate in dichloromethane as solvent. After evaporation of the solvent, a PLLA/palladium-II acetate film covered the pore walls. Next the template was treated at 300° C. in vacuo. Under these conditions, PLLA is completely decomposed, and palladium converted to the metallic state.

In a second step, the palladium-coated pore walls were wetted with liquid polystyrene (PS) in order to form cladded-core fibers with an external Pd layer and internal polymer layer. FIG. 17a shows a transmission electron micrograph of a Pd/PS composite fiber. The outer layer is formed of palladium crystallites with a domain size of a few nanometers. Energy dispersive X-ray microanalysis (EDX) of individual composite fibers confirmed the presence of Pd (FIG. 17b) . As expected, the K_{α} and K_{β} peaks of C and the L_{α} and L_{β} peaks of Pd and a signal due to the silicon substrate onto which the composite fibers had been applied for the examination could also be detected. Electron diffraction on individual composite fibers confirmed the presence of metallic palladium (FIG. 17c) . The (111), (200), (220), (311) and (331) reflections from cubic palladium can be discerned. From FIG. 17d, it can clearly be seen that the composite fibers consist of an inner PS layer and an outer Pd layer. Parts of the outer Pd layer were detached by 30 minute exposure to ultrasound, so that the inner PS layer was exposed. This is apparent on the basis of the chemical contrast in FIG. 17d and was confirmed by energy dispersive X-ray microanalysis and electron diffraction experiments.

### EXAMPLE 15

### Production of Arrays of Palladium-Coated Microcavities and Palladium Nanotubes

The process according to the invention can be used for the production of arrays of metal-coated microcavities and of metal nanotubes. The templates are wetted with a mixture of a metal precursor and a selectively removable polymer, where, in an advantageous possible embodiment, a solvent acts as a carrier. Depending on the choice of the carrier and the selectively removable polymer, in a particularly advantageous embodiment of the process a fine phase morphology can be created by spinodal segregation. By further processing steps, the metal precursor is converted into the metal and the polymer removed.

By way of example, the coating of porous aluminum oxide templates may be described. These were cleaned as described in Example 3. A solution of polylactide and palladium acetate in dichloromethane was dripped onto the templates. By evaporation of the dichloro-methane, spinodal segregation was firstly induced, then the material solidified. Next, the template was tempered in vacuo for 1 hr at temperatures of up to 350° C. During this, the polylactide and the acetate were completely removed by pyrolysis and the palladium, which was originally present in the +2 oxidation state, converted to metallic palladium. A hybrid material resulted, in which the pore walls of the porous aluminum oxide were coated with palladium nanoparticles. In order to be able to examine the coating by scanning electron microscopy, the template was removed with aqueous KOH. FIG. 18a shows an array of Pd nanotubes thus obtained, and FIG. 18b details of the morphology. It can be discerned that different morphology types of differing roughness and porosity can be obtained. Cross sections through Pd nanotubes are shown in FIGS. 18c and 18d, and transmission electron microscopy, energy dispersive X-ray microanalysis and electron diffraction showed that the tubes consisted of metallic palladium.

### EXAMPLE 16

### Production of Polyether ether Ketone Nanotubes

A macroporous silicon template was wetted at 380° C. with poly(oxy-1,4-phenyleneoxy-1,4-phenylenecarbonyl-1,4-phenylene), a polyether ether ketone (PEEK). After cooling, the template was selectively removed, as a result of which PEEK nanotubes were obtained, as shown in FIGS. 19a and 19b.

Through the present invention, a generally applicable process for the production of nanotubes, particularly in the form of ordered polymer hollow fiber arrays, is provided. The hollow fibers can be produced with any polymer system whatever that can be processed in the liquid state (e.g. as melt or solution). The production of hollow fibers by wetting of porous templates with polymer-containing liquids can thus be used for the manufacture of hollow fibers for a wide range of applications in nanotechnology.

1. A process for the production of hollow fibers with an external diameter from 10 nm to 100 μm, which contain at least one polymer, comprising the steps:
(a) provision of a porous template material,
(b) introduction of a liquid containing at least one polymer into the pores of the template material in such a manner that the pore walls are wetted by the liquid, but the pores are not completely filled with liquid,
(c) solidification of the liquid and
(d) optionally at least partial removal of the template material.

2. The process for the production of hollow fibers of nonpolymeric materials with external diameters from 10 nm to 100 μm, comprising the steps:
(a) provision of a porous template material,
(b) introduction of a liquid containing at least one polymer and at least one nonpolymeric material into the pores of the template material in such a manner that the pore walls are wetted by the liquid, but complete filling of the pores does not take place,
(c) solidification of the liquid
(d) selective, at least partial removal of the polymeric components,
(e) optionally chemical conversion of the nonpolymeric material remaining in the pores and
(f) optionally at least partial removal of the template material.

3. The process as claimed in claim 1 or 2, characterized in that the liquid is introduced into the pores as a melt of a polymer or a mixture of polymers, which optionally contains further additives.

4. The process as claimed in claim 3, characterized in that the melt is produced by heating to a temperature above the solidification temperature of the polymer or the polymer mixture.

5. The process as claimed in claim 4, characterized in that the melt is produced by heating to a temperature which is at least 30% above the solidification temperature of the polymer or the polymer mixture.

6. The process as claimed in one of claims 3 to 5, characterized in that the liquid is solidified by cooling of the melt.

7. The process as claimed in claim 1 or 2, characterized in that the liquid is introduced into the pores as a solution, suspension or/and emulsion of a polymer or a polymer mixture, which optionally contains further additives, in a carrier or carrier mixture.

8. The process as claimed in claim 7, characterized in that the liquid is solidified by removal of the carrier.

9. The process as claimed in one of claims 1 to 8, characterized in that the liquid contains at least one polymer with number average molecular weights (Mn) of more than 100,000 D, preferably more than 500,000 D, especially preferably more than 1,000,000 D.

10. The process as claimed in one of claims 1 to 9, characterized in that the liquid contains at least one polymer with a molecular weight distribution with a dispersity <2.5, preferably <2.0, especially preferably <1.10.

11. The process as claimed in one of claims 1 to 10, characterized in that the liquid contains at least one partially crystalline or crystalline polymeric component and the degree of crystallinity of the hollow fibers is preferably adjusted by tempering of the filled template material over a selected time period at a selected temperature above the glass transition temperature and below the melting temperature of the partially crystalline or crystalline component or/and by cooling of the melt at a selected cooling rate.

12. The process as claimed in one of claims 1 to 11, characterized in that phase transition processes are induced in the material wetting the pore walls.

13. The process as claimed in claim 12, characterized in that the induction of segregation processes is effected in the liquid, as a result of which hollow fibers with regions of differing material composition are produced.

14. The process as claimed in claim 13, characterized in that segregation processes are induced between several polymers or/and between polymers and carriers.

15. The process as claimed in claim 13 or 14, characterized in that the segregation processes are induced by temperature changes or/and by altering the composition of the liquid, preferably by evaporation of a volatile component.

16. The process as claimed in one of claims 12 to 15, characterized in that a phase separation is induced in the liquid and a maturation of the segregation morphology is induced by tempering at a selected temperature above the solidification temperature over a selected time period, and this maturation process is frozen in by means of a temperature change, preferably with a temperature change of more than 10 K/min, especially preferably more than 100 K/min.

17. The process as claimed in one of claims 13 to 16, characterized in that hollow fibers with pores in the fiber wall are produced through the segregation process.

18. The process as claimed in one of claims 1 to 17, characterized in that the liquid is introduced into a template material which is rotating, preferably at more than 500 RPM, especially preferably at more than 2,000 RPM.

19. The process as claimed in one of claims 1 to 18, characterized in that during the introduction of the liquid into the template material ultrasound acts on the liquid.

20. The process as claimed in one of claims 1 to 19, characterized in that hollow fibers are produced which contain at least two coexisting phases and at least one phase is selectively removed from the hollow fibers, preferably by extraction, action of radiation, chemical, biological or thermal degradation, action of ultrasound or combinations thereof.

21. The Process as claimed in one of claims 1 to 20, characterized in that a template material which contains arrays of pores parallel to one another is used.

22. The Process as claimed in at least one of claims 1 to 21, characterized in that a template material which contains arrays of pores whose length deviates less than 15%, preferably less than 5%, especially preferably less than 1%, from the average pore length is used.

23. The process as claimed in at least one of claims 1 to 22, characterized in that a template material which contains pores with an aspect ratio from 1 to 20,000, preferably 10 to 20,000 and especially preferably 1,000 to 20,000 is used.

24. The process as claimed in at least one of claims 1 to 23, characterized in that a template material which contains pores with a pore diameter from 10 nm to 100 μm is used.

25. The process as claimed in one of claims 1 to 24, characterized in that a template material which contains pores with a deviation from the average pore diameter of <5%, preferably of <1% is used.

26. The process as claimed in one of claims 1 to 25, characterized in that a template material which displays a pore density of more than 10⁴ pores/cm², preferably more than 10⁵ pores/cm², especially preferably more than 10⁶ pores/cm² is used.

27. The process as claimed in one of claims 1 to 26, characterized in that a template material in which pores are arrayed in a regular manner, preferably in a hexagonal, trigonal or square lattice or in a graphite lattice, is used.

28. The process as claimed in claim 27, characterized in that a template material which displays a lattice constant which is less than 100 nm, preferably less than 10 nm, especially preferably less than 1 nm, larger than the average pore diameter is used.

29. The process as claimed in one of claim 1 to 28, characterized in that a template material uses pores selected from
(i) blind pores,
(ii) pores open at both ends,
(iii) defect pores starting from main pores, with pore depths smaller than the distance between adjacent main pores and pore diameters smaller than the pore diameters of the main pores,
(iv) pores starting from main pores, which form a linkage between different main pores, and combinations thereof.

30. The process as claimed in one of claims 1 to 29, characterized in that the wall thickness of the hollow fibers is from 1 nm to 1 μm.

31. The process as claimed in one of claim 1 to 30, characterized in that the polymer is selected from
(i) organic polymers, such as poly(p-xylylene), polyether imides, polyaryl ether ketones, polysulfones, poly(phenylene sulfides), polyacrylamides, polyimides, polyesters, polyolefins, polystyrenes, polycarbonates, polyamides, polyethers, polyphenylenes, polysilanes, polysiloxanes, polybenzimidazoles, polybenz-thiazoles, polyoxazoles, polysulfides, polyester amides, polyarylenevinylenes, polylactides, polyether ketones, polyurethanes, polysulfones, ormocers, polyacrylates, silicones, fully aromatic copolyesters, poly-N-vinylpyrrolidone, polymethacrylates such as polyhydroxymethyl methacrylate or polymethyl methacrylate, polyterephthalates such as polyethylene terephthalate or polybutylene terephthalate, polymethacrylonitriles, polyacrylonitriles, polyvinyl acetates, neoprene, buna N, polybutadiene and halogenated polyolefins such as polyvinylidene fluoride or polytetrafluoroethene, and dendrimers,
(ii) biological polymers, such as polysaccharides, for example cellulose (modified or unmodified), alginates or polypeptides such as for example collagen,
(iii) polymers built up of two or several different repeating units, preferably in the form of block copolymers, graft copolymers or dendrimers and
(iv) combinations of several organic polymers or/and biological polymers.

32. The process as claimed in one of the foregoing claims, characterized in that
(a) the liquid to be introduced into the template material contains at least one metal-containing compound, which is preferably selected from components which
(i) contain a metal, in particular platinum, palladium, gold, silver, nickel, rhodium, ruthenium, manganese, titanium or chromium, another main group or transition metal or combinations of different metals,
(ii) contain an organometallic compound or another metal-containing compound, in particular platinum, palladium, gold, silver, nickel, rhodium, ruthenium, manganese, titanium or chromium, another main group or transition metal or combinations of different metals,
(iii) are semiconductor materials,
(iv) alloys of semiconductor materials and/or
(v) precursor compounds for semiconductor materials,
(b) the organometallic compounds are optionally transformed by suitable methods, preferably chemical, biological, thermal or/and photochemical processes or/and by the action of radiation or/and plasma.

33. The process as claimed in claim 32, characterized in that the transformation comprises the conversion of the metal-containing compound, for example an organometallic compound, into a metal or metal oxide.

34. The process as claimed in claim 32, characterized in that the transformation comprises the conversion of the metal-containing compound, for example a semiconductor precursor compound into a semiconductor compound.

35. The process as claimed in one of claims 1 to 34, characterized in that after the solidification of the liquid the template material is at least partly degraded thermally, chemically, biologically, in a radiation-induced manner, photochemically, by plasma, ultrasound, microwaves or/and extraction with a solvent.

36. Porous materials, preferably polymer membranes, metal oxides, ceramics, metals or metalloids and semiconductors, especially preferably aluminum oxide or silicon, obtainable as claimed in one of claims 1 to 35, characterized in that the inner walls of their pores are at least partially coated with a solid material which contains at least one polymer.

37. Porous materials, preferably polymer membranes, metal oxides, ceramics, metals or metalloids and semiconductors, especially preferably aluminum oxide or silicon, obtainable as claimed in one of claims 1 to 35, characterized in that the inner walls of their pores are coated with a nonpolymeric material, in particular with a metal oxide and/or a metal, preferably in the form of particles with dimensions <50 nm, especially preferably with nanoparticles of a metal oxide or/and a metal with dimensions <3 nm.

38. Hollow fibers with an external diameter from 10 nm to 100 μm which contain at least one polymer, obtainable as claimed in one of claims 1 to 35.

39. Hollow fibers with an external diameter from 10 nm to 100 μm which contain at least one nonpolymeric material, obtainable as claimed in one of claims 2 to 35.

40. The hollow fibers as claimed in claim 38 or 39, characterized in that their diameter is constant over their whole length.

41. The hollow fibers as claimed in one of claims 38 to 40, characterized in that both fiber ends are open, one fiber end is open or both fiber ends are closed and a hollow space is enclosed.

42. The hollow fibers as claimed in one of claims 38 to 41, characterized in that their surfaces display pores, preferably with pore diameters of less than 500 nm, especially preferably of less than 100 nm, quite especially preferably of less than 10 nm.

43. The hollow fibers as claimed in one of claims 38 to 42, characterized in that they display a rough or/and structured surface.

44. The hollow fibers as claimed in one of claims 38 to 43, characterized in that their specific surface area is >10 m²/g, preferably >100 m²/g, especially preferably >500 m²/g.

45. The hollow fibers as claimed in one of claims 38 to 44, characterized in that their surface to volume ratio is >100 m²/m³, preferably >1,000 m²/m³, especially preferably >10,000 m²/m³.

46. The hollow fibers as claimed in one of claims 38 to 45, characterized in that their aspect ratio is ≧100, preferably ≧1,000, especially preferably ≧10,000.

47. The hollow fibers as claimed in one of claims 38 to 46, characterized in that the inner side or/and the outer side of their surface is coated with a further material or a further material mixture, preferably by chemical gas phase deposition, physical gas phase deposition, vapor deposition, sputtering, laser ablation or wetting, currentless deposition or/and electrodeposition.

48. The hollow fibers as claimed in one of claims 38 to 47, characterized in that their inner volume is completely or partially filled with a further material or a further material mixture, preferably by chemical gas deposition, physical gas deposition, currentless deposition or/and electrodeposition.

49. The hollow fibers as claimed in one of claims 38 to 48, characterized in that they contain at least two different polymers in selected mixing ratios.

50. The hollow fibers as claimed in one of claims 38 to 49, characterized in that they contain regions of differing material composition, preferably dished morphologies, especially preferably interpenetrating morphologies.

51. The hollow fibers as claimed in one of claims 38 to 50, characterized in that they contain a partly open surface, which in the direction of the fiber axis has the length of the fibers, but does not take up the whole extent of the surface.

52. The hollow fibers as claimed in one of claims 38 to 51, characterized in that they contain at least one partially crystalline or crystalline component and the degree of crystallinity is <40%, preferably <10%, especially preferably <5%.

53. The hollow fibers as claimed in one of claims 38 to 52, characterized in that they contain at least one partially crystalline or crystalline component and the degree of crystallinity is >40%, preferably >60%, especially preferably >85%.

54. Arrays of hollow fibers which contain several hollow fibers as claimed in one of claims 38 to 53.

55. The arrays of hollow fibers as claimed in claim 54, characterized in that several hollow fibers are arrayed parallel.

56. The arrays of hollow fibers as claimed in claim 55, characterized in that several hollow fibers through parallel arrangement form a freestanding membrane or are attached parallel on a substrate.

57. The arrays as claimed in one of claims 54 to 56, which are characterized by a regular array of the hollow fibers, preferably in a hexagonal, trigonal or square lattice or in a graphite lattice.

58. The arrays as claimed in one of claims 54 to 57, which have an area of more than 25 μm², preferably of more than 500 μm², especially preferably of more than 1 cm².

59. The arrays as claimed in one of claims 54 to 58, characterized in that
(i) the apertures of the hollow fibers are open on one side of the array,
(ii) the apertures of the hollow fibers are open on both sides of the array or/and
(iii) the apertures of the hollow fibers are closed on both sides of the array.

60. The arrays as claimed in one of claims 54 to 59, characterized in that the arrays are linked to substrates on both sides.

61. The arrays as claimed in one of claims 54 to 60, characterized in that the hollow fibers are embedded in a matrix.

62. The arrays as claimed in one of claims 54 to 61, characterized in that the average spacing between the hollow fibers assumes values between double the radius of the hollow fibers and 100 μm.

63. The arrays of hollow fibers as claimed in one of claims 54 to 62 which contain hollow fibers with a deviation from the average fiber size of <5%, preferably <1%.

64. The arrays of hollow fibers as claimed in one of claims 54 to 63 which display a hollow fiber density of more than 10⁵ fibers/cm², preferably more than 10⁶ fibers/cm², especially preferably more than 10⁷ fibers/cm².

65. The arrays of hollow fibers as claimed in one of claims 54 to 64, characterized in that they contain deliberately introduced defect sites.

66. The arrays of hollow fibers as claimed in one of claims 54 to 65, wherein the hollow fibers are materially linked together, preferably by short fiber segments running perpendicular to the fiber axis of the hollow fibers.

67. Powders which consist of hollow fibers as claimed in one of claims 38 to 53.

68. The use of the hollow fibers as claimed in one of claims 38 to 53 for the production of nonwoven or woven textiles.

69. The use of the hollow fibers as claimed in one of claims 38 to 53 as components in medical devices, for example artificial lungs, in microelectronics as wire, cable, waveguides or capacity, in superlight construction technology, in medical separation technologies, in capillary electrophoresis, in scanning probe microscopy, in catalytic systems, in fuel cells, in batteries or in electrochemical reactors.

70. The use of the hollow fibers as claimed in one of claims 38 to 53 as sensor components, as microreactors, as protein storage, as drug delivery systems, as composite materials, as fillers, as mechanical reinforcement, as heat insulators, as dielectrics, as piezoelectric control elements, as interlayer dielectrics in chip manufacture, as separation media, as storage media for gases, liquids or particle suspensions or as materials in the clothing industry.

71. The use of porous materials as claimed in claim 36 as microcell arrays in combinatorial chemistry and combinatorial materials research.

72. The use of porous materials as claimed in claim 36 as components in medical devices, for example artificial lungs, in superlight construction technology, in medical separation technologies, in capillary electrophoresis, in scanning probe microscopy, in catalytic systems, in fuel cells, in batteries or in electrochemical reactors, as sensor components, as microreactors, as protein storage, as drug delivery systems, as composite materials, as fillers, as mechanical reinforcement, as heat insulators, as dielectrics, as piezoelectric control elements, as interlayer dielectrics in chip manufacture, as separation media, as storage media for gases, liquids or particle suspensions, as materials in the clothing industry or as functionalized surfaces with specific adhesion, tack and wetting properties.

73. The use of arrays of hollow fibers as claimed in one of claims 54 to 66 as microcell arrays in combinatorial chemistry and combinatorial materials research.

74. The use of arrays of hollow fibers as claimed in one of claims 54 to 66 as components in medical devices, for example artificial lungs, in superlight construction technology, in medical separation technologies, in capillary electrophoresis, in scanning probe microscopy, in catalytic systems, in fuel cells, in batteries or in electrochemical reactors, as sensor components, as microreactors, as protein storage, as drug delivery systems, as composite materials, as fillers, as mechanical reinforcement, as heat insulators, as dielectrics, as piezoelectric control elements, as interlayer dielectrics in chip manufacture, as separation media, as storage media for gases, liquids or particle suspensions, as materials in the clothing industry or as functionalized surfaces with specific adhesion, tack and wetting properties.
